(19) United States
(12) Patent Application Publication
(10) Pub. No.: US 2016/0269802 A1
(43) Pub. Date: Sep. 15, 2016

(54) Reverse Video Multiplexing over IP (Reverse Multiplexing over IP)

(71) Applicant: John King Piraino, Woodland Hills, CA (US)

(72) Inventor: John King Piraino, Woodland Hills, CA (US)

(21) Appl. No.: 14/718,442

(22) Filed: May 21, 2015

Related U.S. Application Data
(60) Provisional application No. 62/177,255, filed on Mar. 10, 2015.

(30) Foreign Application Priority Data
Apr. 3, 2015 (US) 177255

(51) Int. Cl. H04N 21/643; H04N 21/2381; H04N 21/434; H04N 21/236; H04N 21/61; H04N 21/2362

(52) U.S. Cl. CPC H04N 21/64322; H04N 21/6125; H04N 21/2362; H04N 21/4344; H04N 21/4348; H04N 21/23605; H04N 21/2381

(57) ABSTRACT

This patent documents a software and hardware strategy for vastly improving the speed of streaming video, HD movies or any other large real-time (streaming and other) data sets broadcast over the Internet that will:

(a) solve the speed and other commercial problems associated with Internet broadcasts,
(b) satisfy end user demands for receiving, viewing/hearing broadcast material without starts and stops and
(c) satisfy governmental, regulatory, political and public requirements by maintaining Internet Neutrality^{[2]} while providing a method that also reduces the per gigabyte processing burden on Internet servers.

In October 2014 CNN and other news outlets reported growing pressure from internet related broadcasters and their lobbyists to directly “purchase” larger Internet “bandwidths”. Broadcasters and their end users faced problems of poor reception, “starts-and-stops” and dropped sections for Internet broadcasts. This continued to be a problem both for content providers (such as Netflix and others) and for manufacturers of streaming interfaces (Apple, Roku, etc.). Streaming interfaces capture Internet broadcasts and transfer the signals to end users' computers, TVs or other devices.

The public outcry against preferential treatment for commercial interests was nearly universal. The Internet was developed with public funds. It was supposed to be the New Electronic Age of Democratic communication. If commercial interests could purchase unfair advantages with higher bandwidths (for their use alone) it could end the “democratic” Internet. Preserving the democratic Internet became codified in a policy of “Internet Neutrality” or ‘Net Neutrality’.

By October 2014 debate has grown so intense regarding Net Neutrality that public debate reached Congress and the White House. President Obama intervened and, in the end, FCC regulations were added that supported the continuing principle of Internet Neutrality.

As I watched the debate and reports I asked myself “Why do they need a special dispensation from Congress to accelerate IP transmission speed? Don't they have some clever engineers who can figure out how to improve transmission speed within the existing Internet paradigms?”

Then it dawned on me. I had the solution, which follows:

What if three broadcasters simultaneously transmitted a third of the data associated with one HD movie? Each broadcaster would take its fair share of Internet bandwidth and the movie would get to the end user in almost ⅓ the time. But that would be impossible to coordinate.

However, what would it look like if one broadcaster created three virtual broadcaster servers? You would still have 3 broadcast servers transmitting one third the data, simultaneously, and the data would reach the end users' sites in about ⅓ the time.

I also realized that if HD movies were pre-parsed into bite sized data elements the net processing load on the Internet would be reduced since web servers (that parse and route data) would not be forced to parse large inbound data streams. For HD movies transmitted dozens, hundreds or even thousands of times a day, Internet processing would be hugely reduced. The HD movie's pre-parsed data elements would also put fewer burdens on the Internet servers near the end user site because those servers would not have to re-integrate the data stream. In this new technology re-integration is done at the user site. Implementing this strategy would require adding servers to the broadcast site and adding software and hardware to streaming interfaces such as Apple, Hulu, Netflix or others.

After years of my own frustration at trying to get decent streaming reception, would I spend an extra $100 to get a great streaming interface? Or pay an extra $5-10/month? Absolutely Yes! (I had already spent hundreds of dollars on other technologies to solve this problem without luck.)

Would Apple, Hulu and Netflix be happy for another billion dollars of revenue with an effective streaming solution? Would the public welcome a more reliable, faster, more error-free method to view movies online without the typical starts and stops? The obvious seems to be “Yes!”.

Instead of decrying why so many smart people in large companies do not think outside the box, I decided to take action. I decided to file a patent for a technology I call Reverse (Video) Multiplexing over IP or simply RVM/IP.

### Multiplexing and IP Functions: Traditional Methods

Many patents exist for the transmission of digital television (DTV) and other big data sets over Internet Protocol (IP). Patents include Program and System Information Protocol (PSIP) data associated with a DTV data stream including PSIP data for a virtual channel table (VCT), an event information table (EIT) which includes (1) a source identification field that identifies the source of an event (broadcast) of the DTV data stream; (2) an event identification field; (3) a start time field indicating a start time of the event; (4) a title field indicating a title of the event; and (5) a descriptor field with a descriptor tag identifying descriptor as a genre descriptor; (6) a descriptor field for length and (7) at least one category code for associated events that specify genre, program type, category and other information.

The new patent ideas are referred to as RVM/IP, an abbreviation of Reverse (Video) Multiplexing over Internet Protocol. The digital television (DTV) data stream that is used to compare traditional methods to the new RVM/IP methods is referred to as the DS-1 data stream. All other data streams should be presumed to be traditional data streams. Understanding how traditional broadcast methods work is key to understanding the scope of the new ideas in the new RVM/IP methods.

Traditional Multiplexing integrates data from a single DTV data stream with other inbound IP data. If the data stream is too large to transmit all at once, it is broken into data packets (or frames) in a parsing process performed by an Internet gateway server. The gateway server also assigns PSIP data. Parsing is a computer-implemented method for establishing (format) consistency for files having inconsistent internal data structures, as typically found in video, audio or other types of data streams. Parsing creates small data packets in the traditional broadcasting methodology. The new RVM/IP process will create smaller data elements that are (a) similar to data packets, but (b) optimized for Internet transmission and (c) reassembly at an end user site without using Internet servers for parsing or reassembly work.

In traditional parsing processes the destination, sort, order, descriptor, timing and other data is put in data packets' header information. Data packets created by traditional parsing processes are interleaved (shuffled or multiplexed together) with all other data packets from all other inbound data streams. Data packets wait their turn in a sequential cue before it is broadcast. Data packet #1 from a given data stream could wait for hundreds of other data packet transmissions before data packet #2 two is finally transmitted. The wait starts over again for data packet #3.

In the new RVM/IP process, data packets are not created by the Internet servers. Instead the job of parsing has already been done by the broadcast server before data is sent to the Internet. This is called “pre-parsing”, a key strategy for RVM/IP. RVM/IP data elements are similar to data packets except they are optimized for transmission and “dis-associated” (made discrete) from all other data elements. Discrete data elements should not require parsing by the gateway web server (since they are optimally sized) and will also avoid placing the costly processing burden on the Internet gateway server (because they are discrete). In traditional and RVM/IP methods the data packets (and data elements) will still wait their turn in the multiplexed transmission cue. However, the RVM/IP data elements will not be further delayed by web-based parsing or by web-based reassembly.

When data packets (traditional) and data elements (RVM/IP) reach the end user's local internet server those data packets/elements are de-multiplexed. That is, the local end users' Internet server separates data packets/elements from all other data with which they have been interleaved.

In the traditional method the local (end user) web server reassembles data packets based on timing stamps and other PSIP data to ensure sequential integrity. Each portion of the re-integrated data stream must (again) wait its turn before being transmitted to the end user. However, in the RVM/IP method the web server does not and cannot “re-assemble” the data elements; instead that re-assembly process is done at the end user site further reducing the burden on web processing.

In traditional methods re-integrated data packets wait until their turn comes around again before sending the next re-assembled data packets to the end user. This constantly intervening “wait state” may contribute to end users' experience of “starts-and-stops”, bad reception, or dropped sections.

RVM/IP data elements will need to be de-multiplexed just as traditional data packets, but the much larger burden of reassembly, under RVM/IP, will be vastly faster in this “last mile” of transit.

See FIG. 1 in Drawings for “Traditional Method” schematic.

See FIGS. 2, 3, and 4 in Drawings for “RVM/IP Methods” schematics.

### RVM/IP Broadcast Compared to Traditional: Four Independent Claims (Overview)

The concepts of this patent fall into 4 major categories:

(A) How pre-parsing and data organization vary between RVM/IP and traditional broadcasting.
(B) How Internet broadcast strategy varies between RVM/IP and traditional methods.
(C) How technologies at the end user site vary between RVM/IP and traditional methods.
(D) How RVM/IP has enormous additional opportunities for other applications in addition to the improvement of transmission speed and integrity; it can also provide greater transmission security, including secure virtual, nearly “un-hackable”, websites.

(A) Pre-parsing: Instead of relying on web servers to parse data streams into “bite sized data packets”, RVM/IP “pre-parses” the data stream (an HD movie, video, etc.) on the main broadcast server before any broadcast goes live. Pre-parsing in the Broadcast server creates the data element (which is similar to a data packet but “smaller”) and assigns it a sequence number to guide the data stream re-assembly at the end user site. This avoids parsing by web servers on the Internet which can introduce errors. This RVM/IP strategy also reduces the “processing burden” on web servers.

The Pre-parsing maintenance process allows broadcasters to more thoughtfully manage parsing as conditions change. In other words, pre-parsed data elements on the broadcast server can be optimally sized and configured based on data stream content, configurations of the broadcast site (including the main broadcast server and associated servers), the broadcaster's local internet gateway structure and other factors. Proper balance will boost transmission speeds.

The main point of pre-parsing is to reduce the load on the Internet and speed up the transmission of data elements to end users. (Imagine the load on the Internet as its resources are used to parse a popular HD movie 10,000 times a day!) But . . . this improvement alone will not solve speed issues. As we examine RVM/IP transmission and End User technologies we will refer to the RVM/IP data stream of interest (an HD movie, video, etc.) as “DS-1”. Data elements (not data packets) that make up DS-1 are the pre-parsed elements that are stored in the broadcast server. See FIG. 3.

(B) Transmission: Instead of relying on a single server to sequentially broadcast a data stream over the Internet, RVM/IP uses “Virtual Broadcast Servers” (VBS) which have been populated with pre-parsed discrete data elements. All VBS systems simultaneously broadcast their portion of data elements to the Internet. If 3 VBS systems broadcast a third of the elements at the same time, the data elements will “fill up” the available Internet pathways 3 times faster, and will be transmitted 3 times faster. Since RVM/IP data elements are discrete, they rapidly “slip through” the web servers to the Internet, especially since there is no delay for parsing at the point of entry. See FIGS. 2 and 3.

(C) End User Receipt: Instead of waiting for web servers near end user sites to re-integrate the data stream, discrete RVM/IP data elements pass directly to the end user. Those data elements are re-assembled at the end user site by software and/or firmware added to end user interfaces (EUI) such a Hulu, Roku, Apple, DVRs. Data element sequence numbers guide re-assembly. See FIG. 4

(D) Security and the Virtual Website: The above characteristics (A), (B) and (C), outline the first three independent claims of this RVM/IP patent. The fourth independent claim refers to applications made possible and practical with RVM/IP, including new security strategies and “virtual” websites.

Data security: Even without encryption, an RVM/IP data stream would be difficult to retrieve since the randomly transmitted discrete data elements cannot be easily identified in-transit or re-assembled easily without RVM/IP consolidation at the target end user's site.

The pre-parsing process itself could create more strongly encrypted files by encrypting the data element sequence numbers themselves. Encryption keys could be set at the time of an end user demand and part of the encryption code could be a rotating combination of a unique identifier for the broadcast site plus the user site plus the sequence number, which itself is then encrypted.

Since RVM/IP independently parses data streams of any kind into data elements, a data stream could be computer code, user data, and databases—all in any combination. Since these parts could make up a website, RVM/IP transmission strategy would allow such a (pre-parsed) website to be easily and quickly transmitted between web servers creating, essentially, a “floating” website independent of any physical server. Such a website would be almost completely “un-hackable”.

Reverse Video Multiplexing over IP (RVM/IP) and the more general (Reverse Multiplexing over IP or RM/IP) can be implemented in any network. A key part of RM technologies is the data element sequence number which is stored in the data element separate from the traditional header information stored in the PSIP data (p. 4, para. 1). The sequence number and associated data element are created in the broadcast server one time or at occasional intervals as demanded by changes in Internet traffic or other relevant transmission factors.

RVM/IP transmission strategy has unlimited practical scalability. That is, transmission speed can be increased by different orders of magnitude by varying the number of multiple “virtual” broadcast servers (VBS) used in the RVM/IP transmission process. It is the simultaneous use of multiple virtual broadcast servers that increases transmission speed by orders of magnitude. The VBS systems broadcast data elements in parallel (simultaneously) and, provided the data elements are pre-parsed properly, those data elements should reduce some multiplexing and interleaving in addition substantial reduction in traditional parsing and re-assembly. A win-win for everyone.

Data elements are arranged for reintegration at the end user site back into an HD or standard movie or video (or other data types) by using the data element sequence number which provides the key for re-integration of the data stream at the end user site. In this final phase the Internet based re-integration is moved from the Internet servers to end user devices that perform the data stream re-integration. This further lowers Internet processing burdens.

### Why Call it Reverse Multiplexing?

RVM/IP parsing is done before data is sent over the Internet (not after). RVM/IP re-assembly is done after data reaches the end user (not before). That's partly why the name Reverse multiplexing was chosen. “Reverse” for the reasons above; “multiplexing” because multiplexing is a central technology and central to the idea of Net Neutrality.

### BRIEF DESCRIPTION OF DRAWINGS

FIG. 1 Multiplexing and IP Functions: Traditional Methods (Overview)

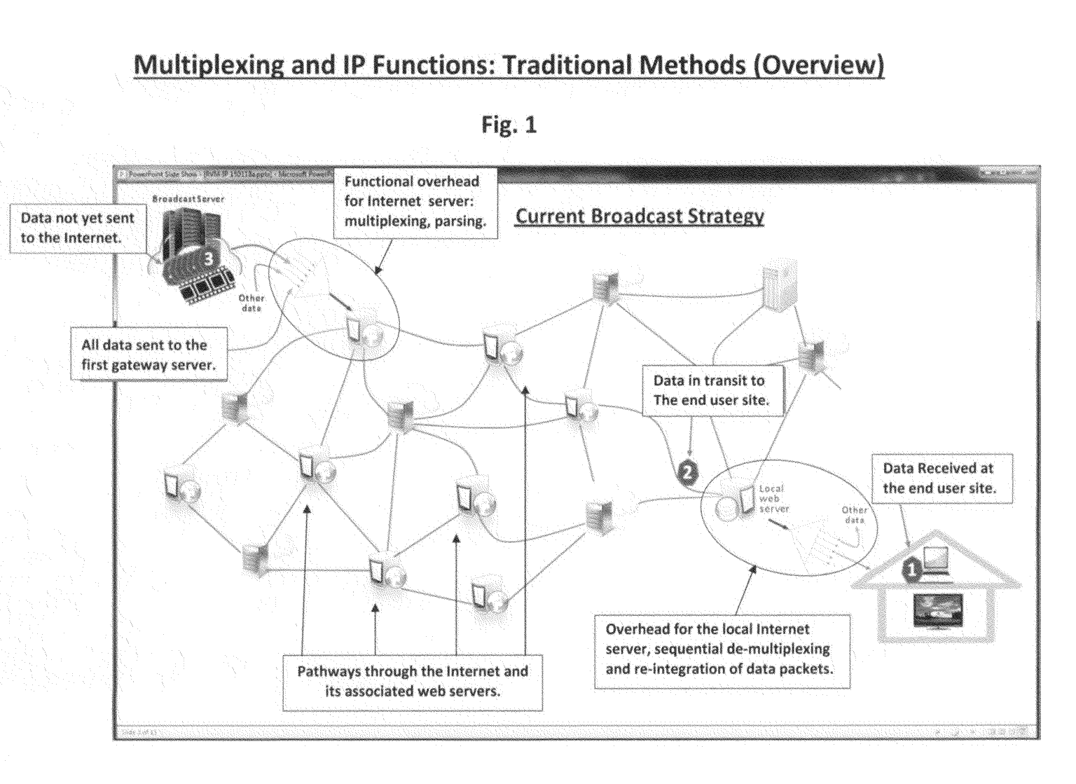

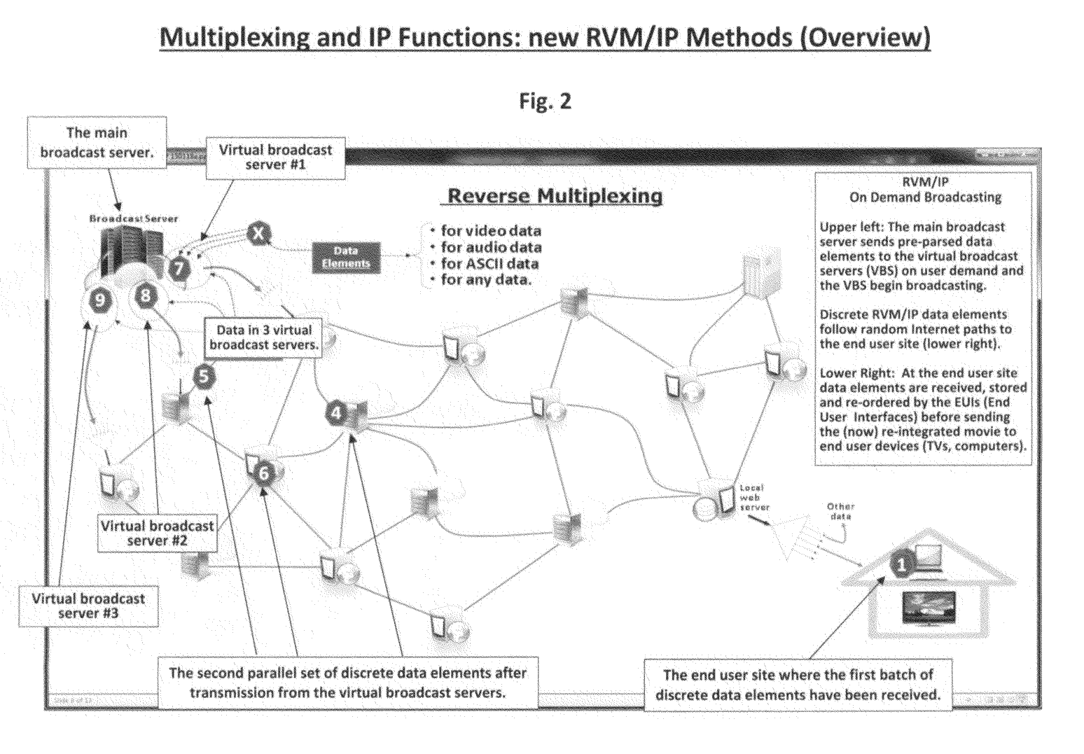

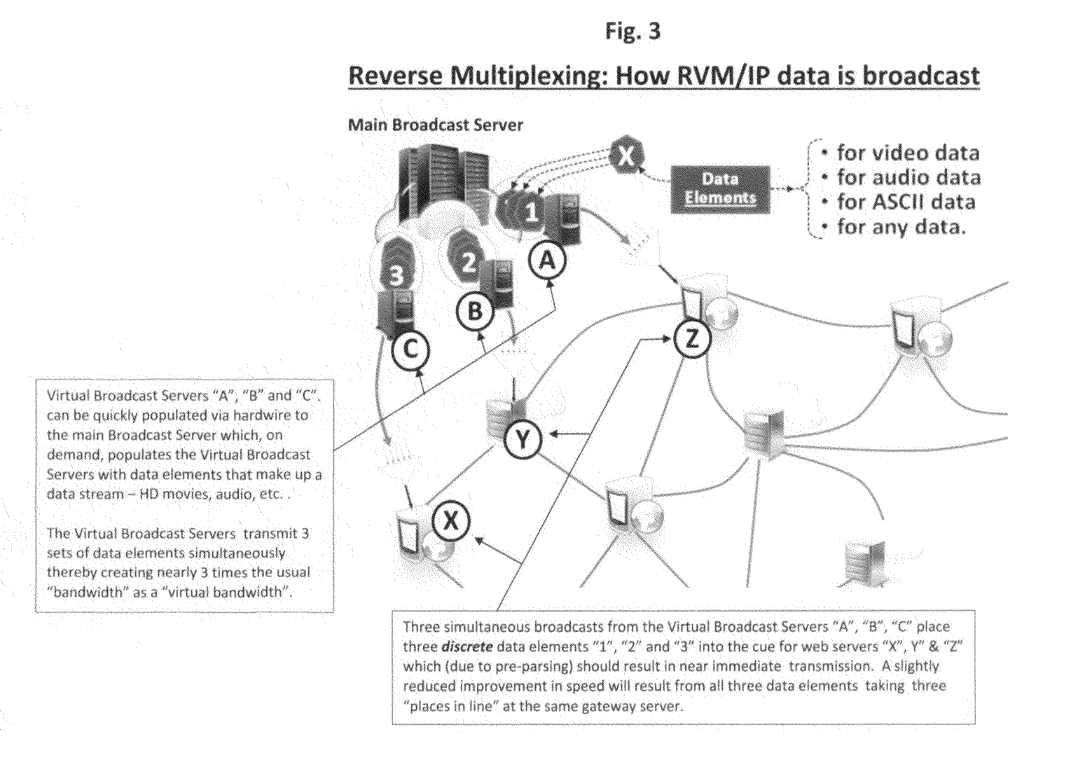

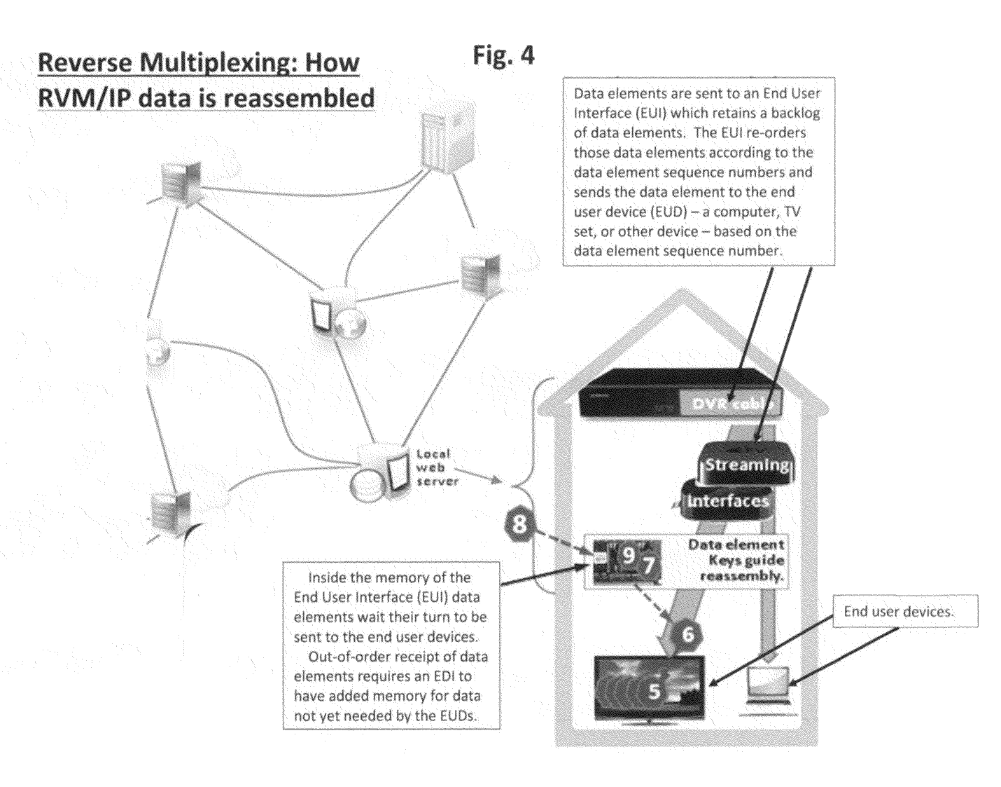

This drawing shows the traditional serial broadcast strategy in action. After the 1^{st} data packet “1” has been received by an end user, data packet “2” nears the end user's local web server for de-multiplexing while the rest of the data (“3”-“xxx”) is about to be transferred from the broadcast server to the Internet gateway server where this remaining data will then be parsed, multiplexed, put into data packets and assigned PSIP data header information by the (original or first) gateway server on the Internet. The last Internet gateway server de-multiplexes and recombines the original parsed data stream and sends it to the end user.

FIG. 2 Multiplexing and IP Functions: new RVM/IP Methods (Overview)

This drawing shows (a) how RVM/IP broadcast strategy uses the same Internet technology, (b) how RVM/IP can reduce the Internet processing burden compared to traditional methods with optimized pre-parsing of the data stream before any data is sent to the Internet (gateway) servers which eliminates the need for added parsing by Internet servers. At the end user site no special recombination is required for discrete elements.

FIG. 3 Reverse Multiplexing: How RVM/IP data is broadcast

This drawing shows how the main broadcast server populates the virtual broadcast servers with discrete data elements like a card dealer deals “cards”. There are (in this case) 3 virtual broadcast servers (VBS) that simultaneously (in parallel) transmit 3 data elements at a time to the first Internet gateway servers available. Any “n” number of VBS can be used. The number “n” describes the order of magnitude of the speed increase.

FIG. 4 Reverse Multiplexing: How RVM/IP data is reassembled.

This drawing shows how the end user site manages the data elements. The local end user Internet server does not need to recombine discrete data elements. That job is managed by the end user interfaces (EUI)—including streaming interfaces, DVRs or other devices. The EUI must be equipped with RVM/IP software that saves and re-orders the data elements for delivery to end user devices such as TV, computers and so on.

1-28. (canceled)

29. Independent Claim (A): A system for speed improvements in broadcasting large data streams across the Internet called Reverse (Video) Multiplexing over Internet Protocol (RVM/IP) that manages the transmission with no change in how the Internet functions, that is, by maintaining Net neutrality while speeding up standard Internet transmission rates, or speeding up any network's transmission rate by starting with the first step at the broadcast site where libraries of pre-parsed “data elements” are created by the broadcast or repository server from large data sets (HD movies, databases, streaming audio/video or even program code etc.) where these data elements are created in a process called pre-parsing, and where the data elements are similar and “smaller” than the corresponding data packets which are created in the Internet gateway server when it receives a large Data Stream (“DS-1”) or broadcast.

30. Dependent Claim: The system of claim 29 (A) whereby data elements created in the broadcast server by “pre-parsing”; reduce the processing load for parsing on the Internet gateway and where pre-parsing DS-1 into discrete data elements allows the broadcaster to optimize (a) how those data elements are configured to maximize transmission speed, (b) ensure data elements are “right sized” to avoid delays by the web (gateway) server, (c) that elements are optimized for the local the Internet configuration and (d) that consideration is given for the destination server (typically but not exclusively at an end user site) and other architectures of the network, its functions, configurations, server(s) and “DS-1” itself.

31. Dependent Claim: The system of claim 29 (A) whereby, when end users demand a broadcast, the stored data elements are transferred directly from the main broadcast server or repository to a number of Virtual Broadcast Servers (VBS) for direct and immediate parallel/simultaneous transmission (no intervening parsing needed).

32. Dependent Claim: The system of claim 29 (A) whereby, when the data stream of an HD movie, streaming video, or other data stream is pre-parsed into data elements, the broadcast server's new RVM/IP software will also assign a data element sequence number which will be used separately from other PSIP data to perform re-integration of data elements at the end users' sites; sequence number is independent of PSIP data created by the Internet gateway server in the traditional IP methodology.

33. Dependent Claim: The system of claim 29 (A) whereby, when data element sequence numbers are added to data elements in the main broadcast server, other data must be added to the Program & System Information Protocol (PSIP) data to ensure that the Internet gateway server recognizes that the data elements are not part of a larger data stream (i.e. that they are discrete data elements) and so will not prompt parsing of the data elements into yet more data packets.

34. Dependent Claim: The system of claim 29 (A) whereby, A-practical methods to ensure data elements are formed as (a) “discrete” and (b) “right sized” in the pre-parsing process includes (a) testing that the PSIP data elements (that flag the gateway web server that indicates a data element does not belong to a greater data stream) actually work the same as if the Internet gateway server had assigned PSIP to a truly discrete element and (b) testing the size and (other) characteristic qualities of the data element in an actual transmission to a gateway web server, even if existing specifications are available on that gateway server or if existing specifications would form a good starting point and where, in time, it is likely that these processes will be continually perfected so as to become automatic—and therefore fully automated.

35. Independent Claim (B): The architectural strategy of using local multiple broadcast servers in a coordinated parallel (multiple simultaneous) transmission of data elements, properly marked and transmitted, to increase transmission speeds over the Internet, or any network, where other “competing” transmissions are present and configured so that an increase in transmission speed is directly proportional to the number of simultaneously transmitting broadcast servers.

36. Dependent Claim: The architectural strategy of claim 35 (B) so that instead of relying on a single server to sequentially broadcast parallel data streams over the Internet on user request, RVM/IP uses “Virtual Broadcast Servers” (VBS) to broadcast the pre-parsed data elements of the DS-1 data stream where for each VBS system used, the speed will increase by an order of magnitude so if “n” VBS are broadcasting, the speed will increase by “n” fold if the processes in claims #37-#41 are also implemented as described.

37. Dependent Claim: The architectural strategy of claim 35 (B), to maximize efficiency from the VBS systems' parallel broadcast of data elements, the data elements must be rapidly transferred from the broadcast server or repository to each VBS at the time of user demand and data elements must be distributed like a dealer would deal cards where, e.g., if there are 3 VBS, the broadcast server “deals” 3 data elements to VBS A, B and C and the VBS transmit immediately which means 1,2,3 are transmitted simultaneously; the same for elements 4,5,6 and so on, since if data elements are not dealt like playing cards to VBS systems, substantial delay will occur; E.g. if data elements 1, 75 and 189 are dealt out of order and sent to the VBS, the end user will still have to wait until element 2 is sent which could be delayed substantially, thereby defeating the point of multiple simultaneous broadcasts.

38. Dependent Claim: The architectural strategy of claim 35 (B) requires that the main broadcast server should be as close to “hard wired” to the VBS as possible to ensure that transfer of data elements from the broadcast server to the VBS occurs much faster than the rate at which the VBS transmit their data to the Internet gateway.

39. Dependent Claim: The architectural strategy of claim 35 (B) suggests that optimal speed gains should be achieved by VBS parallel broadcasting to different Internet (gateway) servers and will most closely provide an “n” order of magnitude improvement in the transmission speed for “n” VBS, however, data elements broadcast in parallel to the same Internet gateway server (instead of separate gateway servers) may result in slower transmission times, but these discrete elements will still consume 3 “places in line” at the single gateway server and so still create substantial speed improvements, and in the latter case speed results will vary but should still approximate the order of magnitude for improved speed, less, perhaps, some percentage.

40. Dependent Claim: The architectural strategy of claim 35 (B) assumes the broadcast servers will be processing end user requests at a high volume every minute and, as a result, there must be feedback loops from the VBS systems back to the main broadcast server that signals a “pause” when sufficient DS-1 data elements have been loaded into the VBS and similarly there is a feedback loop from end users' streaming devices that tells the VBS to “pause” transmission across the Internet when sufficient volumes of data elements have been collected for the feed to end user devices.

41. Dependent Claim: The architectural strategy of claim 35 (B) enables the transmission of data elements by the VBS immediately after the main broadcast server begins populating the VBS with pre-parsed data elements, so long as element transfers follow the process described in dependent claims #37 and #38.

42. Independent Claim (C): A system for the re-integration of a data stream under RVM/IP to ensure that most of the de-multiplexing and re-integration process burden on the Internet server near the end user is transferred to end user devices where data elements are put back in order at the end user site using data element sequence numbers as described in claim #32 so that when the first few data elements are properly sorted, they are transmitted, on cue, to end user devices (EUD) including computers, TV screens, or other typical devices that perform this function along with End User Interfaces (EUI) that include streaming interfaces, Cable DVR machines and others, where these EUI devices will need additional software, memory and perhaps firmware or hardware so that transmission from the EUI devices to the EUD are controlled in the same manner as in traditional broadcasting—that is, as soon as data element “n” is processed, data element “n+1” follows on a timed flow rate.

43. Dependent Claim: The system of claim 42 (C) whereby software and/or firmware must be in the end users' streaming interface, DVR or other interface device at the end user site that receives the DS-1 data elements which would require that manufacturers such as Apple, Roku, etc., will need to add this software/firmware to their streaming interfaces.

44. Dependent Claim: The system of claim 42 (C) whereby manufacturers will also need to add memory to their end user (streaming) interfaces since a backlog of data elements must have a storage area to be held until the moment they are ready for transfer to end user devices.

45. Dependent Claim: The system of claim 42 (C) whereby smooth operation requires that the data elements received should fill EUI memory much faster than those data elements are needed for transfer to end user devices, and that, at some point this temporary memory will be used up and the Software must send a message to the VBS at the main broadcast site to momentarily pause transmission of data elements until the streaming interface's temporary memory has enough empty space to re-start VBS transmission.

46. Dependent Claim: The system of claim 42 (C), at the end user site, requires a methodology for determining if the transmission received is part of a larger data stream (parsed in the traditional fashion) or part of an RVM/IP transmission (pre-parsed) which is easy since a “blank” data element sequence number indicates a normal (traditional) transmission and a non-blank sequence number indicates the transmission is part of an RVM/IP parallel transmission which is further defined by the PSIP data.

47. Dependent Claim: The system of claim 42 (C) requires End User Interfaces (EUIs) such as streaming interfaces, DVRs and the like, to manage the inbound data elements and that End User Devices (EUDs) such as computers, TVs or cell phones, display the inbound data from Streaming Interfaces that read data directly from an Internet transmissions and DVRs (generally) that read data from transmissions over dedicated cable lines, phone lines, or satellite links where, in either case, RVM/IP strategies require that the EUDs provide a feedback loop to the EURs to manage the flow of data and the EURs provide feedback to the main broadcast server in the traditional methods and it is likely that the EURs can probably use the same or similar technique to provide feedback to the Virtual Broadcast Servers (VBS) in the RVM/IP method while bearing in mind that an EUD that includes RVM/IP technology will itself require RVM/IP software, memory and perhaps firmware and/or hardware; however, for dedicated cable, VPN or other similar networks, RVM/IP may not necessarily improve performance.

48. Independent Claim (D): A new system paradigm of security can be created for existing traditional system paradigms by utilizing RVM/IP technology which can improves transmission security by providing fault-tolerant random transmission pathways that have no negative effect on the transmission, its data elements, or its ability to re-integrate data while creating in transmission, a “new” system so that the various data elements could much less easily be intercepted since there is no standard PSIP data identifying which elements are part of a whole, and since the entire “picture” (so to speak) would not be a coherent whole until its data elements all reached the end user site and were re-integrated and, in the case where large data transfers require more security than speed, the data elements' sequential transmission can be easily altered to random (1,75,459) instead of (1,2,3) in such a way that would make this latter point especially valuable in the implementation of a “virtual website” that could duplicate and transfer itself indefinitely leaving no clear or obviously coherent trace, since a website, after all, is simply a collection of multiple data types that include software code, drivers, communication routines, databases, screens and graphics.
